(19) United States
(12) Patent Application Publication
(10) Pub. No.: US 2020/0064689 A1
(43) Pub. Date: Feb. 27, 2020

(54) LIGHTING DEVICE AND DISPLAY DEVICE INCLUDING THE SAME

(71) Applicant: SHARP KABUSHIKI KAISHA, Sakai City (JP)

(72) Inventors: HISASHI WATANABE, Sakai City (JP); HIROTOSHI YASUNAGA, Sakai City (JP); YOUZOU KYOUKANE, Sakai City (JP); TAKESHI MASUDA, Sakai City (JP)

(21) Appl. No.: 16/550,948

(22) Filed: Aug. 26, 2019

Related U.S. Application Data
(60) Provisional application No. 62/723,150, filed on Aug. 27, 2018.

(51) Int. Cl. G02F 1/1335

(52) U.S. Cl. CPC G02F 1/133603; G02F 1/133608; G02F 1/133605; G02F 1/133611

(57) ABSTRACT

A lighting device includes: a board; at least one light source provided on the board; at least one support member provided on a region on the board where no light source is provided; and an optical member disposed so as to face the at least one light source. A first metal part and a second metal part are provided on the board. The at least one light source is connected to the board via the first metal part while the at least one support member is connected to the board via the second metal part. The first, metal part and the second metal part are made of the same material. A height from the board to a top surface of the at least one support member is higher than a height from the board to a top surface of the at least one light source.

### CROSS-REFERENCE TO RELATED APPLICATION

The present application claims priority benefits from U.S. Provisional Application Ser. No. 62/723,150 filed Aug. 7, 2018.

### BACKGROUND OF THE INVENTION

### Field of the Invention

The present invention relates to a lighting device such as a backlighting device, and a display device including the lighting device.

### Description of the Related Art

Lighting devices such as a backlighting device include so-called direct-lit type devices. In the direct-lit type device, a plurality of light, sources is arranged behind a display element. Light is emitted from the light sources behind the display element and illuminates the display element entirely and uniformly.

The direct-lit lighting device is mainly adopted to products that seek for high luminance and high contrast, such as televisions and digital signage devices, by controlling the amount of light emitted from the light sources individually or for each region (known as local dimming control). Recently, the use of the direct-lit lighting devices has expanded to in-vehicle compact display devices. The direct-lit lighting device includes: a board; a plurality of light sources formed on the board; and an optical member disposed so as to face the plurality of light sources.

In the above-described direct-lit lighting device, it is difficult to fix, to the board, a support member that supports the optical member. For example, in order to decrease the thickness of the direct-lit lighting device, it is the most simple and effective way to mount the light sources on the board such that the light sources are arranged at a pitch as small as possible. However, as the light sources are arranged at a smaller pitch, it is further difficult to reliably fix the support member supporting the optical member to the board. That is, since the support member is generally produced by resin molding using a mold (for example, see JP H10-326517 A paragraph [0006]), there is a limit to miniaturize the support member. Also, even when a support member further miniaturized can be molded, then it is difficult to reliably fix such a miniaturized support member to the board. For example, in the case in which the support member is inserted into the board, a shaft for insertion will be thin, which leads to unstable insertion. In the case in which the support member is adhered to the board by adhesive tape or the like, the adhesive strength will be insufficient. In the result, it is difficult to arrange the support member at a small clearance between the light sources on the board. On the other hand, in the case in which no support member is arranged, the optical member is likely to bend when a lighting device is provided in a display device, especially in a relatively large display device, which results in generation of luminance unevenness caused by the bend of the optical member. Furthermore, the light sources are damaged or do not function well because of the optical member that bends and comes into contact with the light sources. This problem becomes pronounced when the lighting device is applied to devices such as in-vehicle devices or mobile devices, to which vibration is inevitable.

An object of the present invention is to provide a lighting device in which a support member supporting an optical member is reliably fixed to a board, and a display device including the lighting device.

### SUMMARY OF THE INVENTION

(1) In an embodiment of the present invention, a lighting device is provided, which includes: a board; at least one light source provided on the board; at least one support member provided on a region on the board where no light source is provided; and an optical member disposed so as to face the at least one light source. In the lighting device, a first metal part and a second metal part are provided on the board. The at least one light source is connected to the board via the first metal part while the at least one support member is connected to the board via the second metal part. The first metal part and the second metal part are made of the same material. A height from the board to a tap surface of the at least one support member is higher than a height from the board to a top surface of the at least one light source.

(2) Also, in an embodiment of the lighting device of the present invention, in addition to the configuration as described in the above item (1), the support member includes: a support member body; and a top surface part provided on a top surface of the support member body.

(3) Also, in an embodiment of the lighting device of the present invention, in addition to the configuration as described in the above item (2), the optical member comes into contact with the top surface part.

(4) Also, in an embodiment of the lighting device of the present invention, in addition to the configuration as described in any one of the above items (1) to (3), a rear surface of the support member is connected to the second metal part.

(5) Also, in an embodiment of the lighting device of the present invention, in addition to the configuration as described in any one of the above items (1) to (4), the support member is electrically connected to the second metal part.

(6) Also, in an embodiment of the lighting device of the present invention, in addition to the configuration as described in any one of the above items (1) to (5), the light source and the support member are respectively connected to the first metal part and the second metal part, each via a connection part.

(7) Also, in an embodiment of the lighting device of the present invention, in addition to the configuration as described in the above item (6), the connection part is a solder part formed by soldering.

(8) Also, in an embodiment of the lighting device of the present invention, in addition to the configuration as described in any one of the above items (1) to (7), the second metal part is connected only to the support member.

(9) Also, in an embodiment of the lighting device of the present invention, in addition to the configuration as described in any one of the above items (1) to (8), the second metal part is grounded.

(10) Also, in an embodiment of the lighting device of the present invention, in addition to the configuration as described in any one of the above items (1) to (9), the first metal part is constituted of a plurality of metal parts, and the second metal part is constituted of a single metal part.

(11) Also, in an embodiment of the lighting device of the present invention, in addition to the configuration as described in any one of the above items (1) to (10), a surface of the support member, which is connected to the second metal part, is made of a metal.

(12) Also, in an embodiment of the lighting device of the present invention, in addition to the configuration as described in any one of the above items (1) to (11), a plurality of light sources is provided, and the support member is arranged at a center or a substantial center of two or more of the plurality of light sources surrounding the support member.

(13) Also, in an embodiment of the lighting device of the present invention, in addition to the configuration as described in any one of the above items (1) to (12), a plurality of light sources is provided, and the plurality of light sources is arranged at a pitch of 1.0 to 5.0 mm.

(14) Also, in an embodiment of the lighting device of the present invention, in addition to the configuration as described in the above item (2), the top surface part is a shock-absorbing layer.

(15) Also, in an embodiment of the lighting device of the present invention, in addition to the configuration as described in the above item (2) or (14), the top surface part is made of a material that transmits light at a light transmittance that is equal to or higher than a predetermined light transmittance.

(16) Also, in an embodiment of the lighting device of the present invention, in addition to the configuration as described in the above item (2) or (14), the top surface part is made of a material whose external surface at least reflects light at an optical reflectance that is equal to or higher than a predetermined optical reflectance.

(17) Also, in an embodiment of the lighting device of the present invention, in addition to the configuration as described in any one of the above items (2) and (14) to (16), the top surface part has a convex part.

(18) Also, in an embodiment of the lighting device of the present invention, in addition to the configuration as described in any one of the above items (1) to (17), the support member includes a side surface that reflects light at an optical reflectance equal to or higher than a predetermined optical reflectance or that is covered by a cover member made of a material that reflects light at the optical reflectance equal to or higher than the predetermined optical reflectance.

(19) Also, in an embodiment of the lighting device of the present invention, in addition to the configuration as described in the above item (3), a contact part of the support member with the optical member has a curved shape.

(20) Also, in another embodiment of the present invention, a display device is provided, which includes the lighting device having the configuration as described in any one of the above items (1) to (19).

With the present invention, the support member to support the optical member can be easily fixed between the adjacent light sources.

### BRIEF DESCRIPTION OF THE DRAWINGS

FIG. 1 is a schematic cross-sectional view illustrating a liquid crystal display including a backlighting device according to the first embodiment.

FIG. 2 is an enlarged schematic plan view illustrating the backlighting device in FIG. 1, from which the optical member and the like are omitted.

FIG. 3 is a circuit diagram illustrating an example of a circuit structure of light sources connected to an external power source.

FIG. 4 is an enlarged schematic cross-sectional view illustrating a part of the backlighting device shown in FIG. 1.

FIG. 5 is an enlarged schematic cross-sectional view illustrating a part of the backlighting device shown in FIG. 1.

FIG. 6 is an enlarged schematic cross-sectional view illustrating a top surface part of a support member of the backlighting device shown in FIG. 1.

FIG. 7 is an enlarged schematic plan view illustrating a part of the light sources and the support member on the board shown in FIG. 2.

FIG. 8 is a schematic diagram illustrating a circuit structure of wirings formed on the board.

FIG. 9 are diagrams for explaining an example for producing the support member.

FIG. 10 is an enlarged schematic cross-sectional view illustrating a part of the backlighting device according to the second embodiment.

FIG. 11 is an enlarged schematic cross-sectional view illustrating a part of the backlighting device according to the third embodiment.

FIG. 12 is an enlarged schematic cross-sectional view illustrating a part of the backlighting device according to the fourth embodiment.

FIG. 13 is an enlarged schematic cross-sectional view illustrating a part of the backlighting device according to the fifth embodiment.

FIG. 14 is an enlarged schematic cross-sectional view illustrating a part of the backlighting device according to the sixth embodiment.

FIG. 15 is an enlarged schematic cross-sectional view illustrating a part of the backlighting device according to the seventh embodiment.

### DESCRIPTION OF THE PREFERRED EMBODIMENTS

Hereinafter, the embodiments of the present invention are described with reference to the drawings. In the following description, the same components are indicated by the same reference signs, and the appellations and functions are also the same. Therefore, detailed description thereof is not repeated.

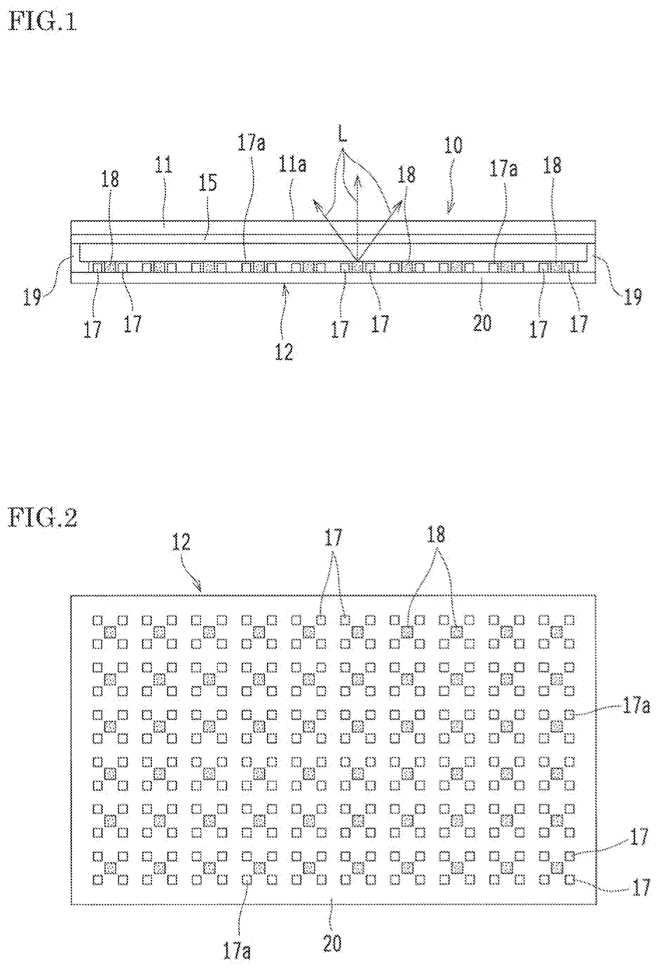

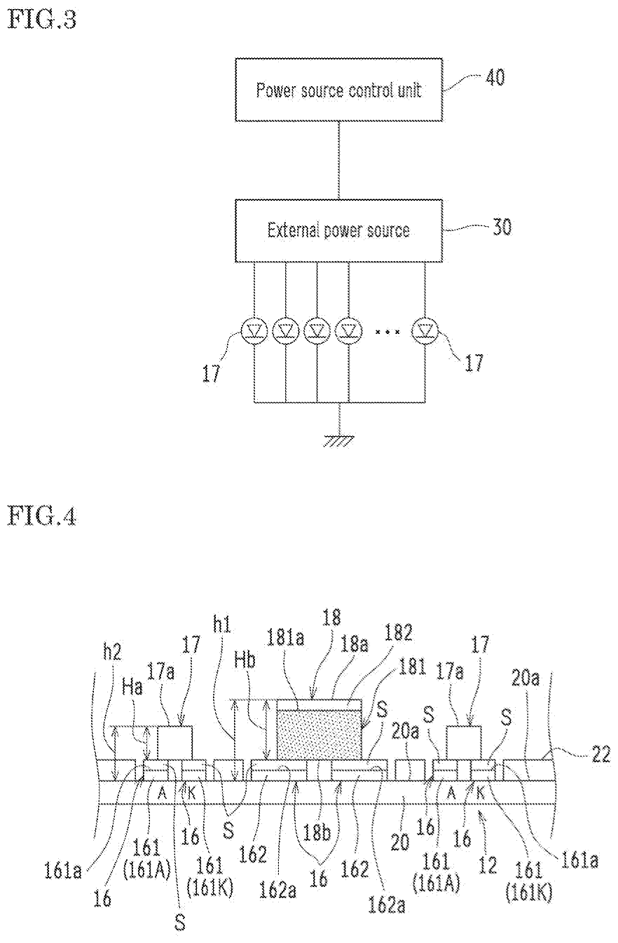

FIG. 1 is a schematic cross-sectional view illustrating a liquid crystal display 10 including a backlighting device 12 according to the first embodiment. FIG. 2 is an enlarged schematic plan view illustrating the backlighting device 12 in FIG. 1, from which the optical member 15 and the like are omitted. FIG. 3 is a circuit diagram illustrating an example of a circuit structure of light sources 17 connected to an external power source 30.

As shown in FIG. 1, the liquid crystal display 10 (an example of the display device) includes: a liquid crystal panel 11 (an example of the display element); and the backlighting device 12 (an example of the lighting device) that illuminates the liquid crystal panel 11 from behind. The liquid crystal display 10 has a rectangular shape in this example, however, the shape is not particularly limited. The liquid crystal display 10 may also have a square shape.

Although the detailed configuration of the liquid crystal panel 11 is not shown in the drawings, the liquid crystal panel 11 has the configuration in which: a pair of glass substrates is bonded to each other at a certain gap; and liquid crystal is encapsulated between the glass substrates.

The backlighting device 12, which is a direct-lit type device, is disposed on the opposite side surface of a display surface 11a of the liquid crystal panel 11. The backlighting device 12 includes: a board 20; a plurality of light sources 17; at least one support member 18; the optical member 15; and a frame 19.

The board 20 is electrically connected, via cables and connectors (not shown), to an external power source 30 controlled by a power source control unit 40 (see FIG. 3). The light sources 17 are lit up by a control current supplied from the external power source 30. The power source control unit 40 performs local dimming control of the external power source 30. Thus, the backlighting device 12 can illuminate the liquid crystal panel 11 with high luminance and high contrast.

### Instant Embodiment

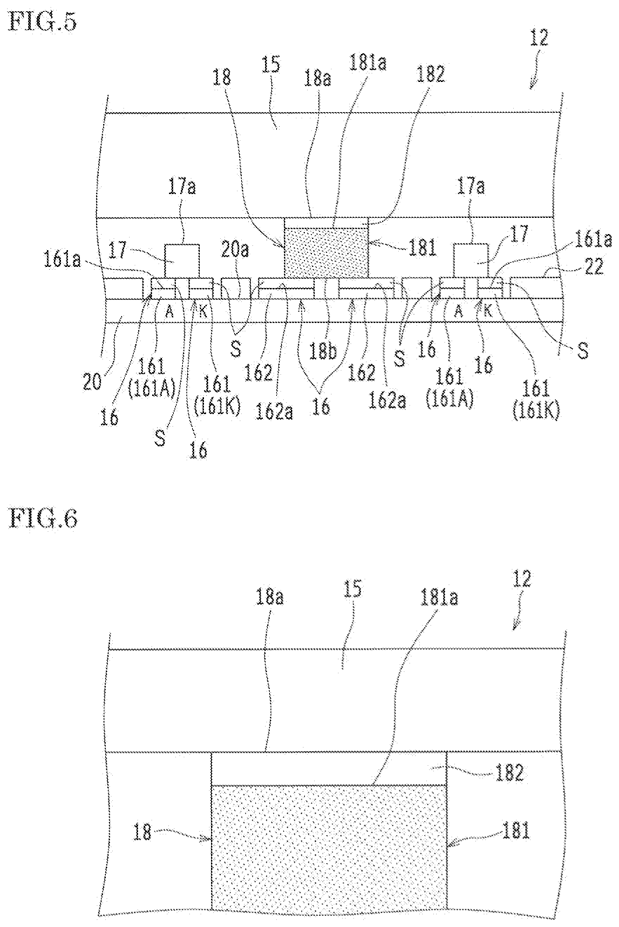

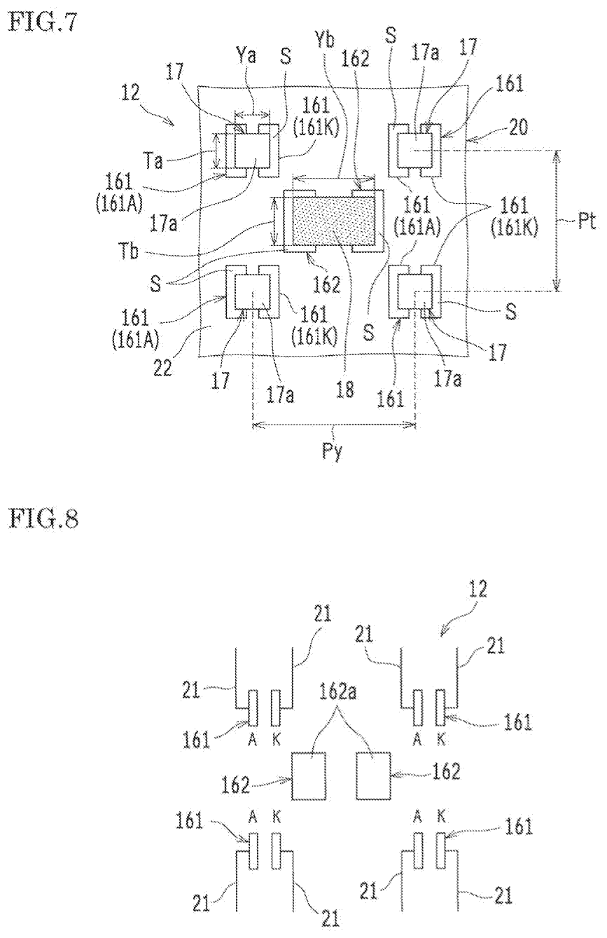

FIGS. 4 and 5 are each an enlarged schematic cross-sectional view illustrating a part of the backlighting device 12 shown in FIG. 1. Note that in FIG. 4, the optical member 15 is omitted. FIG. 6 is an enlarged schematic cross-sectional view illustrating a top surface part 182 of the support member 18 of the backlighting device 12 shown in FIG. 1. FIG. 7 is an enlarged schematic plan view illustrating a part of the light sources 17 and the support member 18 on the board 20 shown in FIG. 2. FIG. 8 is a schematic diagram illustrating a circuit structure of wirings 21 formed on the board 20.

The light sources 17 are formed on the hoard 20. The support members 18 are arranged on the board 20, more specifically, on the region where no light source 17 is formed. The optical member 15 is disposed so as to face the plurality of light sources 17. On the board 20, metal parts 161a (first metal parts) for the light sources and metal parts 162a (second metal parts) for the support members are arranged. Also, the light sources 17 and the support members 18 are connected to the board 20 respectively via the metal parts 161a for the light sources and the metal parts 162a for the support members. The light sources 17 are connected to the board 20 via the metal parts 161a for the light sources while the support members 18 are connected to the board 20 via the metal parts 162a for the support members. The metal parts 161a for the light sources and the metal parts 162a for the support members are made of the same material. Furthermore, the height h1 from the board 20 (from an upper surface 20a) to a top surface 18a of the support member 18 (see FIG. 4) is higher than the height h2 from the board 20 (from the upper surface 20a) to a top surface 17a of each of the light sources 17 (see FIG. 4).

In this way, since the height h1 from the board 20 to the top surface 18a of the support member 18 is higher than the height h2 from the board 20 to the top surface 17a of each of the light sources 17, it is possible to support the optical member 15 without applying any load to the light sources 17. Furthermore, since the support member 18 is connected to the metal part 162a formed on the board 20, it is possible to reliably fix the support member 18 to the board 20. Accordingly, when a lighting device 200 is included in the liquid crystal display 10, especially in the relatively large liquid crystal display 10, the optical member 15 is not likely to bend, which leads to effective prevention of generation of luminance unevenness caused by the bend of the optical member 15. Also, it is possible to prevent the optical member 15 from coming into contact with the light sources 17. Thus, it is possible to avoid damage or malfunction of the light sources 17, which is considerably effective when the lighting device is applied to devices such as in-vehicle devices or mobile devices, to which vibration is inevitable.

(Board)

As the board 20, a general circuit board may be used, such as a rigid board (for example, a board made of a metal material such as aluminum to have a rigidity) or a flexible printed board (for example, a board made of a resin material such as polyimide to have a flexibility). The light sources 17 are mounted respectively on predetermined positions of the board 20.

In the instant embodiment, the board 20 of the backlighting device 12 is coated with a white coating material 22 (specifically, a white resist) so as to increase efficiency in the use of light. The white resist includes, but is not limited to, “PSR-4000” manufactured by TAIYO HOLDINGS CO., LTD. On the board 20 coated with the white resist, the plurality of light sources 17 is arranged in a matrix at a predetermined identical longitudinal pitch Pt and at a predetermined identical lateral pitch Py (see FIG. 7). The light sources 17 emit light L from the respective top surfaces 17a (light emitting surfaces) that are the surfaces opposed to the board 20. In this example, so-called top-view light emitting LEDs are used as the light sources 17. The light sources 17 are chip LEDs mounted on the board 20.

(Light Source)

Representative examples of the light sources 17 include a top emitting type light emitting element (for example, a light emitting diode (LED)) for a general purpose. Examples of the light emitting elements include: a white light emitting element (white LED); and a blue light emitting element (blue LED). All the light sources 17 have the same shape (the same specification). Typically, the shape of the light sources 17 in plan view (i.e. the shape of the top surfaces 17a) may be rectangular, square, elliptical, or circular. The light sources 17 may be mounted on the board 20 at the narrow longitudinal pitch Pt and at the narrow lateral pitch Py both in the range of, for example, 1.0 to 5.0 mm. The longitudinal pitch Pt may equal the lateral pitch Py, or may differ from the lateral pitch Py.

(Support Member)

Examples of the support members 18 include at least an electronic component (chip component) having the height greater than the height of the light sources 17.

It is preferable that a great number of the support members 18 are used because as the number of the support members 18 increases, the optical member 15 is further likely not to bend. However, actually, it is possible to determine the number of the support members 18 in consideration of the component cost and the mounting cost. For example, assuming that a plurality of light sources 17 adjacent to each other (in this example, 4 light sources 17) constitutes one group, one support member 18 or the multiple support members 18 (one support member 18 in the example shown in FIG. 2) can be disposed for each group, for every other group, or for every multiple groups (for every other group in the example shown in FIG. 2).

(Optical Member)

The optical member 15 comes into contact with the support members 18. The optical member 15 is to convert the light emitted from the plurality of light sources 17 (point light sources) into a uniform surface light source of the backlighting device 12. The optical member 15 includes at least one optical member out of, for example: a fluorescence emission sheet; a diffuser panel; a diffuser sheet; a prism sheet; and a polarized light reflection sheet. As the fluorescence emission sheet, a quantum dot enhancement film (“QDEF”, manufactured by 3M Company) may be used, especially it is necessary when the light source is a blue light emitting element (LED). As the diffuser panel, an opal sheet “SUMIPEX” (registered trademark, manufactured by Sumitomo Chemical Co., Ltd.) may be used. As the diffuser sheet, a diffuser film “D114” (manufactured by TSUJIDEN Co., Ltd) may be used. As the prism sheet, a brightness enhancement film (“BEF”, manufactured by 3M Company) may be used. As the polarized light reflection sheet, a dual brightness enhancement film (“DBEF”, manufactured by 3M Company) may be used. However, the optical members are not limited thereto.

(Frame)

On the outer periphery of the backlighting, device body, the frame 19 and/or a bezel that cover(s) at least one side of the outer periphery may be provided in order to fix the components and to prevent light leakage. The frame 19 on the outer periphery is made, for example, of a resin material such as polycarbonate. In the instant embodiment, only the frame 19 is provided. It is preferable that the frame 19 is made of a resin material such as white polycarbonate that has a reflectivity as high as possible.

(Electrode Pad)

On the board 20, electrode pads 16 (electrode connection parts) are disposed. The electrode pad 16 is constituted of: two or more of light-source electrode pads 161 so as to dispose each of the light sources 17: and at least one support-member electrode pad 162 so as to dispose the support member 18. The light-source electrode pads 161 respectively have the metal parts 161a, and the at least one support-member electrode pad 162 each has the metal part 162a. The light-source electrode pads 161 are constituted of a first electrode pad 161A connected to a first electrode (A: anode) of the light source 17 and a second electrode pad 161K connected to a second electrode (K: cathode) of the light source 17. At least one support-member electrode pad 162 is provided relative to one support member 18 (in this example, two electrode pads 162 are provided). Examples of the metal part 161a and the metal part 162a include a metal layer and a metal structure.

In the instant embodiment, a rear surface 18b of the support member 18 is connected to the metal part 162a for the support member. In this way, the support member 18 is provided between the metal part 162a for the support member and the optical member 15. Thus, the optical member 15 can be reliably supported.

In the instant embodiment, the support member 18 is electrically connected to the metal part 162a for the support member. With this configuration, it is possible to use, for example, an electrical component as the support member 18, which means that a ready-made component may be used without separately producing the support member 18. Any electrical component may be used, examples of which include: a chip resistor; a ship capacitor; a chip inductor; a thermistor; a chip light emitting element (LED); and a switch. However, it is preferable to use the chip resistor, since it is typically not expensive. No electrical property is required of these electrical components.

In the instant embodiment, the first electrode and the second electrode of the light source 17 are connected to the metal part 161a for the light source via a connection part S.

In the instant embodiment, the support member 18 and the light source 17 are respectively connected to the metal part 162a for the support member and to the metal part 161a for the light source, each via the connection part S. Thus, it is possible to reliably connect the support member 18 to the metal part 142a. However, the support member 18 may be directly connected to the metal part 162a for the support member without the connection part S.

In the instant embodiment, the connection part S is a solder part formed by soldering. Thus, it is possible to firmly connect the support member 18 to the metal part 162a via the simple configuration of the solder part as the connection part S.

In the instant embodiment, the metal part 162a for the support member is exemplarily shown in the state in which it is not connected to any member other than the support member 18. With this configuration, it is not necessary to provide any wiring connected to the metal part 162a on the board 20, which simplifies the circuit formed on the board 20. Also, when the electrical component is exemplarily used as the support member 18, the kind of the electrical component is not limited since no electrical property is required of the electrical component. Accordingly, any kind of electrical component may be used.

In the instant embodiment, the metal part 162a for the support member is exemplarily shown in the state in which it is grounded. With this configuration, static electricity on the board 20 can be reliably released outside. Thus, it is possible to effectively prevent generation of static electricity.

In the instant embodiment, the surface of the support member 18, which is connected to the metal part 162a, is made of the metal. With this configuration, it is possible to enhance bondability between the support member 18 and the metal part 162a, thus, the support member 18 can be firmly bonded to the metal part 162a.

In the instant embodiment, the plurality of support members 18 is arranged at an equal interval or at a substantially equal interval. With this configuration, the optical member 15 can be evenly or substantially evenly supported by the plurality of support members 18 arranged at the equal interval or at the substantially equal interval. Thus, the optical member 15 can be stably supported by the support members 18.

In the instant embodiment, the support member 18 is arranged at a center or a substantial center of the two or more light sources 17 surrounding the support member 18. Here, the center or the substantial center of the two or more light sources 17 surrounding the support member 18 means the following: when two light sources 17 surround the support member 18, the center or the substantial center between the two light sources 17; and when the three or more light sources 17 surround the support member 18, the center or the substantial center of a polygon whose vertices are the three or more light sources 17 (more specifically, the respective centers of the light emitting points of the light sources 17).

With this configuration, the optical member 15 can be supported by a substantially central part between the light sources 17 surrounding the support member 18. Thus, it is possible to prevent optical influence (for example, luminance unevenness) as possible.

In the instant embodiment, the plurality of light sources 17 is arranged at a pitch of 1.0 to 5.0 mm (at the longitudinal pitch Pt and at the lateral pitch Py).

This configuration can be adapted to the backlighting device 12 in which the respective pitches (Pt and Py) of the light sources 17 are required to be narrow as possible.

When an external force is applied to the optical member 15, the optical member 15 may be damaged because the contact part of the optical member 15 with the support member 18 may be flawed.

In this respect, the support member 18 includes a support member body 181 (see FIG. 5) and the top surface part 182 provided on a top surface 181a of the support member body 181 (see FIG. 5). Since the optical member 15 comes into contact with the top surface part 182 of the support member 18, even when an external force is applied to the optical member 15, the shock can be absorbed by the top surface part 182 of the support member 18. Thus, it is possible to prevent damage of the optical member 15 such as flaws caused by the support member 18. Here, the hardness of the top surface part 182 is smaller than the hardness of the support member body 181.

In the instant embodiment, the top surface part 182 of the support member 18 is a shock-absorbing layer. Thus, even when an external force is applied to the optical member 15, the shock can be further absorbed by the top surface part 182 made of the shock-absorbing layer. Thus, it is further possible to prevent, damage of the optical member 15 such as flaws caused by the support member 18. The shock-absorbing layer can be made of a material having flexibility and/or elasticity.

(Example)

As exemplarily shown in FIG. 7, the light source 17 (LED) is a flip-chip blue LED having the longitudinal size Ta of 0.2 mm, the lateral size Ya of 0.2 mm and the height size Ha of 0.1 mm (see FIG. 4). The light sources 17 were mounted on the board 20 so as to be arranged in a matrix at the longitudinal pitch Pt of 4 mm and at the lateral pitch Py of 4 mm. By high-density mounting of these small components, it is possible to realize the backlighting device 12 having a small thickness and a high evenness. The size of approximately 0.05 mm can be exemplarily shown as the lower limit of the size of the light source 17. If the size of the light source 17 is too small, it is very difficult to mount the light, sources 17 on the board 20. As exemplarily shown in FIG. 7, the chip resistor “UR73D” manufactured by KOA Corporation was used as the support member 18 with the longitudinal size Tb of 1.0 mm, the lateral size Yb of 0.5 mm and the height size Hb of 0.4 mm (see FIG. 4). The light-source electrode pads 161 and the support-member electrode pads 162 were provided on the board 20.

The light-source electrode pad 162 is divided into the first electrode (A: anode) and the second electrode (K: cathode) for the light source 17 (LED). The first electrode pad 161A and the second electrode pad 161K are each connected to an external power source and are individually subjected to lighting control.

The shape of the light-source electrode pad 161 can be adjusted when necessary according to the specification of the light source 17 (LED). Here, the shape of the support-member electrode pad 162 was also adjusted according to the specification of the chip resistor. Since the support-member electrode pad 162 is used for fixing the support member 18, it is not at all needed to be connected to the outside. However, the support-member electrode pad 162 may be grounded so as to prevent generation of static electricity.

Since the support member 18 is illuminated with the light L, it is not preferable, in respect of luminance or evenness, that the support member 18 is too large or that the exterior (external surface) of the support member 18 is black or the like having the optical reflectance lower than a predetermined optical reflectance. Therefore, it is preferable that the support member 18 is as small as possible in the allowable range. However, the support member 18 should be at least higher than the light sources 17 (LEDs). Also it is preferable that the exterior (external surface) of the support member 18 is white or the like having the optical reflectance higher than the predetermined optical reflectance.

The chip resistor “UR73D” having a relatively white exterior (external surface) is a preferable example. Also it is preferable that the exterior (external surface) of the support member 18 is painted white. Furthermore, coating the exterior (external surface) with a soft material such as a silicone resin is preferable since it can prevent damage of the optical member. It is further preferable to use a white silicone resin or a transparent silicone resin (when the exterior is already white).

The light source 17 (LED) and the support member 18 are connected to the board 20 by solder. The backlighting device 12 in which the light sources 17 (LEDs) and the support members 18 are mounted on the board 20 by solder can, for example, be produced by the general steps of reflow soldering.

The position on which the support member 18 is mounted is preferably set at the center of the light sources 17 (LEDs) so as to reduce optical influence as possible. Since the light sources 17 (LEDs) are arranged at an equal interval in order to improve evenness, the support members 18 are accordingly arranged at an equal interval.

In the above first embodiment, the electrical component is used as the support member 18. However, an optimal component may be separately produced.

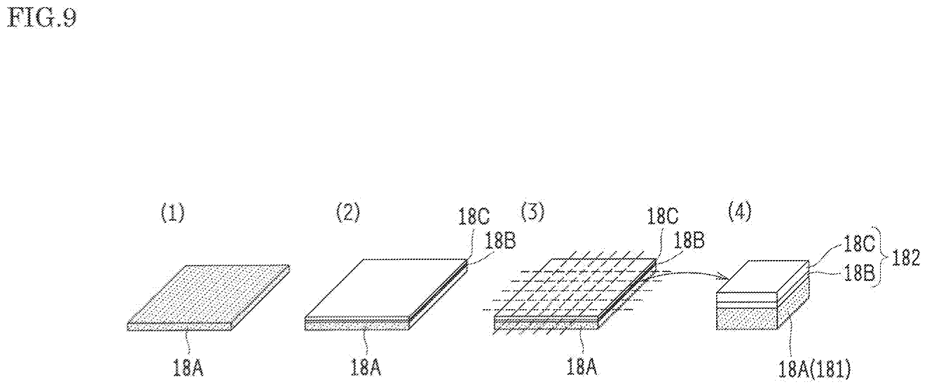

FIG. 9 are diagrams for explaining an example for producing the support member 18. As shown in FIG. 9, desired conditions for the support member 18 are the following:
The height h1 of the support member 18 is as small as possible, but higher than the height h2 of the light sources 17;
As the support member 18, metal materials such as copper, brass, iron and tin can be used, which can be mounted on the metal part 162a on the board 20 by soldering;
The optical reflectance of the exterior (external surface) of the support member 18 is the predetermined optical reflectance or more; and
The contact part of the support member 18 with the optical member 15 is flexible so as to prevent damage of the optical member 15 such as flaws caused by the support member 18.

In order to satisfy the above-described conditions, the support member 18 can be produced, for example, by the following steps:

(1) preparing a base material 18A (for example, a metal material such as a copper plate) having a constant thickness;

(2) applying, entirely onto the base material 18A having the constant thickness, a white paint 18B having an optical reflectance equal to or more than the predetermined optical reflectance and a flexible material 18C such as a silicone resin having flexibility in this order (the white part may be made of the same material as the silicone resin);

(3) after that, cutting the base material 18A coated with the white paint 18B and the flexible material 18C using a dicing method or the like into cut members each having a predetermined size; and

(4) then, painting side surfaces of the cut members if necessary so as to obtain the support members 18.

The support member 18 obtained by the steps as described above has a height h1 at least higher than the height h2 of the light sources 17 when it is mounted on the board 20.

In the support member 18, it is sufficient that only the mounting surface can be soldered. Thus, in the case in which the base material 18A forming the support member 18 is a metal that cannot be bonded by soldering, a thin film made of a material that can be mounted on the metal part 162a on the board 20 by soldering may be formed on the mounting surface of the support member 18 by plating or the like.

### Second Embodiment

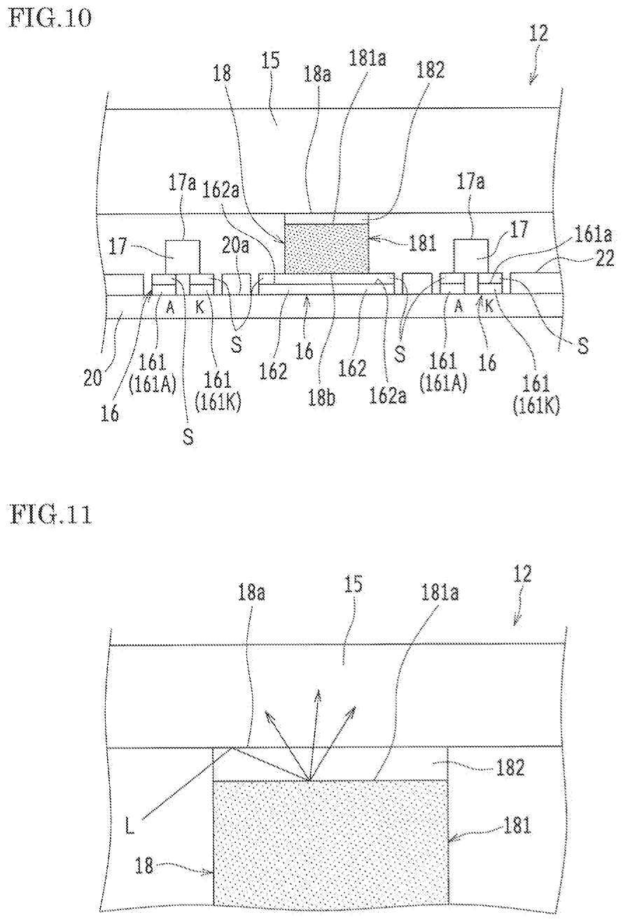

FIG. 10 is an enlarged schematic cross-sectional view illustrating a part of the backlighting device 12 according to the second embodiment. In the backlighting device 12 according to the second embodiment, the two metal parts 162a (i.e. the two support-member electrode pads 162) connected to one support member 18 in the backlighting device 12 according to the first embodiment are formed as one metal part 162a (one support-member electrode pad 162).

In the backlighting device 12 according to the second embodiment, the metal part 161a for the light source is constituted of a plurality of metal parts (i.e. a plurality of light-source electrode pads). The metal part 162a for the support member is constituted of a single metal part (i.e. single support-member electrode pad). In this way, it is possible to increase the connection area of the metal part 162a to the support member 18, which leads to further reliable fix of the support member 18 to the board 20.

### Third Embodiment

FIG. 11 is an enlarged schematic cross-sectional view illustrating a part of the backlighting device 12 according to the third embodiment. In the backlighting device 12 according to the third embodiment, the top surface part 182 of the support member 18 of the backlighting device 12 according to the first embodiment and the second embodiment is made of a material that transmits the light L at a light transmittance that is equal to or higher than a predetermined light transmittance.

The luminance unevenness sometimes occurs under the optical influence of the support member body 181, for example, because of the contact part of the optical member 15 with the support member body 181 that blocks the light.

In this respect, as shown in FIG. 11, the top surface part 182 of the support member 18 is made of a material that transmits the light L at the light transmittance that is equal to or higher than the predetermined light transmittance (for example, a resin material having optical transparency or a transparent resin material). As the predetermined light transmittance, 70 to 100% can be exemplarily adopted. With this configuration, the top surface part 182 of the support member 18 can transmit the light L from the light sources 17. Thus, the light L that is transmitted through the top surface part 182 of the support member 18 can be reflected on the contact part of the support member body 181 with the optical member 15. In this way, it is possible to prevent generation of luminance unevenness under the optical influence of the support member body 181.

### Fourth Embodiment

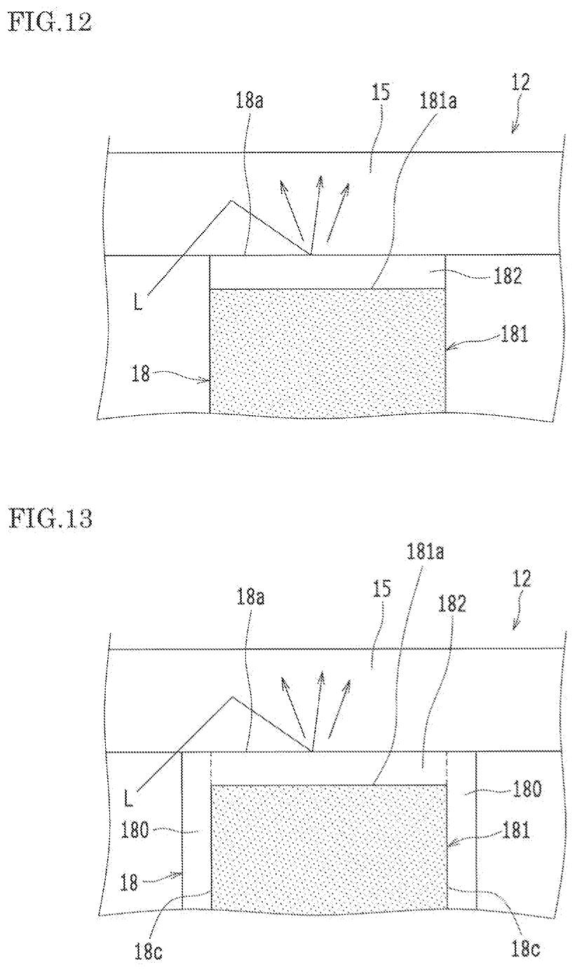

FIG. 12 is an enlarged schematic cross-sectional view illustrating a part of the backlighting device 12 according to the fourth embodiment.

As shown in FIG. 12, in the backlighting device 12 according to the fourth embodiment, the top surface part 182 of the support member 18 of the backlighting device 12 according to the first embodiment and the second embodiment is made of a material whose external surface at least reflects the light L at an optical reflectance that is equal to or higher than a predetermined optical reflectance. As the predetermined optical reflectance, 60 to 100% can be exemplarily adopted. With this configuration, the light L that is reflected on the top surface part 182 of the support member 18 can be further reflected on the contact part of the top surface part 182 with the optical member 15. In this way, it is possible to prevent generation of luminance unevenness under the optical influence of the support member body 181.

### Fifth Embodiment

FIG. 13 is an enlarged schematic cross-sectional view illustrating a part of the backlighting device 12 according to the fifth embodiment.

As shown in FIG. 13, in the backlighting device 12 according to the fifth embodiment, a side surface 18c of the support member 18 of the backlighting device 12 according to the first embodiment to the fourth embodiment reflects the light L at the optical reflectance that is equal to or higher than the predetermined optical reflectance, or the side surface 18c is covered by a cover member 180 made of a material that reflects the light L at the optical reflectance that is equal to or higher than the predetermined optical reflectance. As the predetermined optical reflectance, 60 to 100% can be exemplarily adopted. With this configuration, it is possible to improve the optical reflectance of the side surface 18c of the support member 18, which leads to improvement of efficiency in the use of light.

### Sixth Embodiment

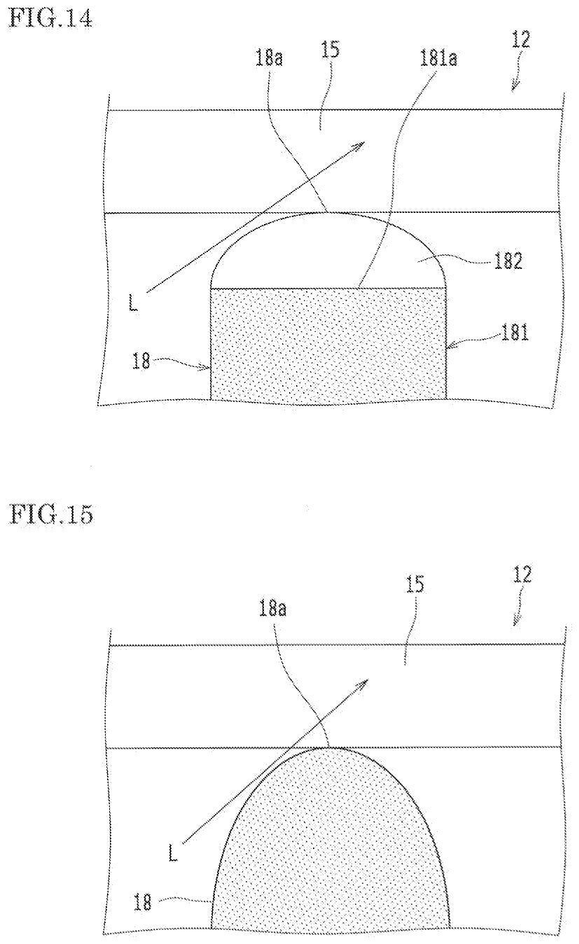

FIG. 14 is an enlarged schematic cross-sectional view illustrating a part of the backlighting device 12 according to the sixth embodiment.

As shown in FIG. 14, in the backlighting device 12 according to the sixth embodiment, the top surface part 182 of the support member 18 of the backlighting device 12 according to the first embodiment to the fifth embodiment has a convex part. With this configuration, it is possible to decrease the contact area of the top surface part 182 of the support member 18 with the optical member 15, which leads to improvement of efficiency in the use of light.

More specifically, the contact part of the support member 18 with the optical member 15 has a curved shape. Thus, it is possible to decrease the contact area of the support member 18 with the optical member 15, which leads to improvement of efficiency in the use of light.

### Seventh Embodiment

FIG. 15 is an enlarged schematic cross-sectional view illustrating a part of the backlighting device 12 according to the seventh embodiment.

As shown in FIG. 15, in the backlighting device 12 according to the seventh embodiment, the support member of the backlighting device 12 according to the first embodiment to the sixth embodiment has a hemisphere shape or a semi-ellipse shape (including a half-oval shape). With this configuration, it is possible to decrease the contact area of the support member 18 with the optical member 15, which leads to further improvement of efficiency in the use of light.

The present invention should not be limited to the above-described embodiments and may be embodied in various other forms. Therefore, the above-described embodiments are to be considered in all respects as illustrative and not restrictive. The scope of the invention is indicated by the appended claims rather than by the foregoing description. All modifications and changes that come within the equivalency range of the appended claims are intended to be embraced therein.

What is claimed is:

1. A lighting device comprising:
a board;
at least one light source provided on the board;
at least one support member provided on a region on the board where the at least one light source is not provided; and
an optical member disposed so as to face the at least one light source, wherein
a first metal part and a second metal part are provided on the board,
the at least one light source is connected to the board via the first metal part,
the at least one support member is connected to the board via the second metal part,
the first metal part and the second metal part are made of a same material, and
a height from the board to a top surface of the at least one support member is higher than a height from the board to a top surface of the at least one light source.

2. The lighting device according to claim 1, wherein the at least one support member includes a support member body; and a top surface part provided on a top surface of the support member body.

3. The lighting device according to claim 2, wherein the optical member comes into contact with the top surface part.

4. The lighting device according to claim 1, wherein a rear surface of the at least one support member is connected to the second metal part.

5. The lighting device according to claim 1, wherein the at least one support member is electrically connected to the second metal part.

6. The lighting device according to claim 1, wherein the at least one support member and the at least one light source are respectively connected to the second metal part and the first metal part, each via a connection part.

7. The lighting device according to claim 6, wherein the connection part is a solder part formed by soldering.

8. The lighting device according to claim 1, wherein the second metal part is connected only to the at least one support member.

9. The lighting device according to claim 1, wherein the second metal part is grounded.

10. The lighting device according to claim 1, wherein
the first metal part is constituted of a plurality of metal parts, and
the second metal part is constituted of a single metal part.

11. The lighting device according to claim 1, wherein a surface of the at least one support member, which is connected to the second metal part, is made of a metal.

12. The lighting device according to claim 1, wherein
the at least one light source comprises a plurality of light sources, and
the at least one support member is arranged at a center or a substantial center of two or more of the plurality of light sources surrounding the at least one support member.

13. The lighting device according to claim 1, wherein
the at least one light source comprises a plurality of light sources, and
the plurality of light sources is arranged at a pitch of 1.0 to 5.0 mm.

14. The lighting device according to claim 2, wherein the top surface part is a shock-absorbing layer.

15. The lighting device according to claim 2, wherein the top surface part is made of a material that transmits light at a light transmittance that is equal to or higher than a predetermined light transmittance.

16. The lighting device according to claim 2, wherein the top surface part is made of a material whose external surface at least reflects light at an optical reflectance that is equal to or higher than a predetermined optical reflectance.

17. The lighting device according to claim 2, wherein the top surface part has a convex part.

18. The lighting device according to claim 1, wherein the at least one support member includes a side surface that reflects light at an optical reflectance equal to or higher than a predetermined optical reflectance or that is covered by a cover member made of a material that reflects light at the optical reflectance equal to or higher than the predetermined optical reflectance.

19. The lighting device according to claim 3, wherein a contact part of the at least one support member with the optical member has a curved shape.

20. A display device comprising the lighting device according to claim 1.
